(19) United States
(12) Patent Application Publication
(10) Pub. No.: US 2012/0107640 A1
(43) Pub. Date: May 3, 2012

(54) PROCESS FOR JOINING CARBON STEEL PART AND SILICON CARBIDE CERAMIC PART AND COMPOSITE ARTICLES MADE BY SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); WEN-FENG HU, Shenzhen City (CN)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 13/170,876

(22) Filed: Jun. 28, 2011

(30) Foreign Application Priority Data
Oct. 29, 2010 (CN) 201010525382.1

(51) Int. Cl. B32B 15/04; B23K 11/16; B32B 18/00

(52) U.S. Cl. 428/623; 219/118; 219/108

(57) ABSTRACT

A process for joining a carbon steel part and a silicon carbide ceramic part, comprising steps of: providing a carbon steel part, a SiC ceramic part, and a Ni foil; bringing surfaces of the carbon steel part, SiC ceramic part, and Ni foil into contact, with the Ni foil inserted between the carbon steel part and SiC ceramic part; applying a pulsed electric current to the parts to be joined, heating the parts to a joining temperature of about 800-1100° C., and simultaneously applying a joining pressure of about 20-60 MPa to the parts while the current is applied, and maintaining the joining temperature and the joining pressure for about 10-30 minutes.

### CROSS-REFERENCE TO RELATED APPLICATIONS

The present application is related to co-pending U.S. Patent Applications (Attorney Docket No. US35127), entitled “PROCESS FOR JOINING STAINLESS STEEL PART AND SILICON CARBIDE CERAMIC PART AND COMPOSITE ARTICLES MADE BY SAME”, by Chang et al. These applications have the same assignee as the present application and have been concurrently filed herewith. The above-identified applications are incorporated herein by reference.

### BACKGROUND

1. Technical Field

The exemplary disclosure generally relates to a process for joining a metal part and a ceramic part, especially to a process for joining a carbon steel part and a silicon carbide ceramic part, and an article made by the process.

2. Description of Related Art

It is desirable to join carbon steel parts and silicon carbide ceramic parts. However, due to distinct physical and chemical properties, it can be difficult to join carbon steel and silicon carbide ceramic by implementing typical bonding methods such as braze welding, fusion welding, and solid diffusion bonding.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary process for joining carbon steel part and silicon carbide ceramic part, and composite article made by the process. Moreover, in the drawings like reference numerals designate corresponding parts throughout the several views. Wherever possible, the same reference numbers are used throughout the drawings to refer to the same or like elements of an embodiment.

FIG. 1 is a schematic cross-sectional view of an example of a spark plasma sintering device for implementing the present process.

FIG. 2 is a cross-sectional view of an exemplary embodiment of the present article made by the present process.

### DETAILED DESCRIPTION

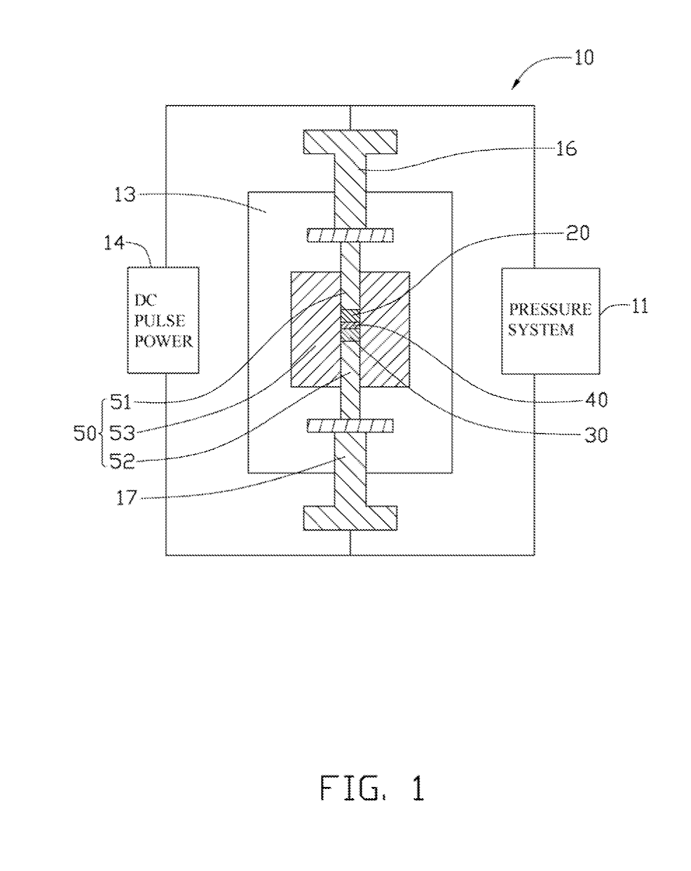

The process according to the present disclosure is generally implemented by a spark plasma sintering (SPS) device as illustrated in FIG. 1.

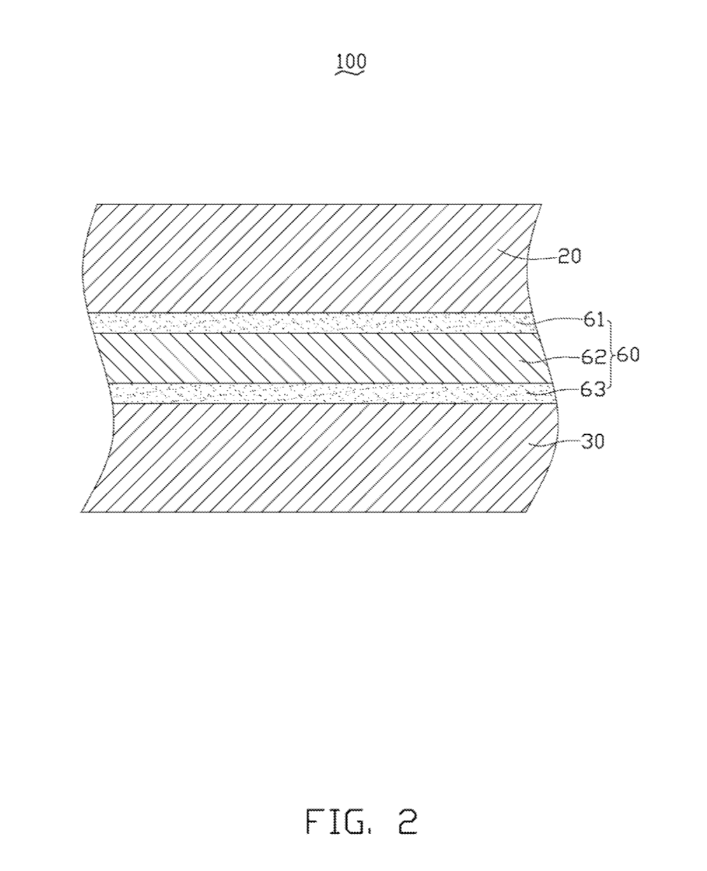

Referring to FIGS. 1 and 2, an exemplary process for joining a carbon steel part and a silicon carbide ceramic part may include the following steps.

A carbon steel part 20, a silicon carbide (SiC) ceramic part 30, and nickel (Ni) foil 40 are provided. The Ni foil 40 is used as a joining medium between the carbon steel part 20 and the SiC part 30. The Ni foil 40 has a thickness of about 0.2-0.4 mm.

The carbon steel part 20, SiC ceramic part 30, and Ni foil 40 are pretreated. The pretreatment may include the step of polishing the surfaces of the carbon steel part 20, SiC ceramic part 30, and Ni foil 40, for example using sandpaper, thus producing smooth surfaces. Then, the carbon steel part 20, SiC ceramic part 30, and Ni foil 40 are ultrasonically cleaned with an organic solution (e.g., alcohol or acetone) in an ultrasonic cleaner, to remove grease from their surfaces. Then, the carbon steel part 20, SiC ceramic part 30, and Ni foil 40 are rinsed with water and dried.

A clamping mold 50 made of electro-conductive material, such as graphite, is used to hold the carbon steel part 20, SiC ceramic part 30, and Ni foil 40. The clamping mold 50 includes an upper pressing member 51, a lower pressing member 52, and a receiving part 53. The receiving part 53 defines a cavity 55 for receiving the carbon steel part 20, SiC ceramic part 30, and Ni foil 40. The upper pressing member 51 and the lower pressing member 52 extend towards the cavity 55 from two opposing directions and can be moved relative to the cavity 55 by a pressure system such as hydraulic pressure system.

The carbon steel part 20, SiC ceramic part 30, and Ni foil 40 are placed into the cavity 55 and clamped by the upper pressing member 51 and lower pressing member 52. The Ni foil 40 is inserted between the carbon steel part 20 and the SiC ceramic part 30. The upper pressing member 51 and the lower pressing member 52 from two opposite sides, bring the surfaces of the parts to be joined into tight contact, accordingly, compressing the carbon steel part 20, SiC ceramic part 30, and Ni foil 40 therebetween.

A SPS device 10 is provided. The SPS device 10 includes a pressure system 11 for providing pressure to the parts to be joined, a sintering chamber 13, and a DC pulse power 14 for providing pulse current to the parts and heating up the parts. In this exemplary embodiment, the SPS device 10 is a “SPS3.20MK-IV” type device sold by SUMITOMO Ltd.

The clamping mold 50 is placed into the sintering chamber 13. The upper pressing member 51 and the lower pressing member 52 are electrically connected to the positive electrode 16 and negative electrode 17 of the DC pulse power 14. The sintering chamber 13 is evacuated to an internal pressure of about 6-10 Pa. A pulsed electric current is applied to the parts to be joined, heating the parts at a rate of about 20 degrees Celsius per minute (° C./min). When the temperature of the parts reaches about 300° C., the parts are heated at a rate of about 80-150° C./min until the temperature reaches the joining temperature of about 800-1100° C. When the temperature of the parts reaches about 300° C., the upper pressing member 51 and the lower pressing member 52 driven by the pressure system 11 begin to press toward each other at about 10 MPa to press the parts clamped therebetween. The clamping pressure applied by the members 51,52 steadily increases, until the temperature of the parts reaches about 850-1100° C., and the clamping pressure reaches about 20-60 MPa. The pressure and temperature are maintained in their respective peak ranges for about 10-30 min, so the Ni foil 40, carbon steel part 20, and the SiC ceramic part 30 react and diffuse with each other to form a joining part 60 (shown in FIG. 2) between the carbon steel part 20 and the SiC ceramic part 30. Thereby, the carbon steel part 20 and the SiC ceramic part 30 are connected via the Ni foil 40, forming a composite article 100. The composite article 100 is removed after the sintering chamber 13 is cooled.

Referring to FIG. 2, in the process of making the composite article 100, a pulsed electric current is applied to the carbon steel part 20, SiC ceramic part 30, and the Ni foil 40. Because there are spaces between the adjacent parts, sparks are created between the spaces. Thereby, high temperature plasma is produced. The spark plasma cleans and activates the surfaces of the parts to improve the diffusion ability of the parts. Furthermore, under the heating of the pulsed electric current, the Ni foil 40 having relative high activity becomes soft and releases Ni atoms. The Ni atoms diffuse onto the carbon steel part 20 and the SiC ceramic part 30 to physically and chemically react with the carbon steel part 20 and the SiC ceramic part 30, thereby a new phase between the carbon steel part 20 and the SiC ceramic part 30 may be formed. The new phase can reduce the internal stress of the SiC ceramic/carbon steel interface, thereby facilitating the diffusion between the carbon steel part 20 and the SiC ceramic part 30. Thus, the carbon steel part 20 can substantially connect to the SiC ceramic part 30 via the Ni foil 40 by spark plasma sintering.

The present process produces a final and permanent joint of maximum strength. The process requires a short hold time and a low vacuum level inside the sintering chamber 13, thus producing significant time and energy savings.

The composite article 100 manufactured by the present process includes the carbon steel part 20, the SiC ceramic part 30, and the now-formed joining part 60 connecting the carbon steel part 20 to the SiC ceramic part 30. The joining part 60 is formed by placing the Ni foil 40 between the carbon steel part 20 and the SiC ceramic part 30, and then heating by applying a pulsed electric current and pressing the carbon steel part 20 and the SiC ceramic part 30 as described. The joining part 60 results from interaction between the Ni foil 40, carbon steel part 20, and the SiC ceramic part 30. In particular, the joining part 60 includes:

a) a first transition layer 61: The first transition layer 61 is adjacent to the carbon steel part 20. The first transition layer 61 results from interaction of the carbon steel part 20 and the Ni foil 40. The first transition layer 61 mainly includes Ni-Fe solid solutions, and intermetallic compounds comprising Ni and Fe;

b) a nickel layer 62: The nickel layer 62 is adjacent to the first transition layer 61. The nickel layer 62 results from portions of the Ni foil 40 that do not react with either the SiC ceramic part 30 or the carbon steel part 20; and

c) a second transition layer 63: The second transition layer 63 is located between the nickel layer 62 and the SiC ceramic part 30. The second transition layer 63 results from interaction of the SiC ceramic part 30 and the Ni foil 40. The second transition layer 63 is mainly composed of compounds comprising Ni and C, and compounds comprising Ni and Si.

The joining part 60 of the composite article 100 has no cracks or holes, and has a smooth surface. The carbon steel/SiC ceramic interface of the composite article 100 has a shear strength of about 40-80 MPa.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A process for joining a carbon steel part and a silicon carbide ceramic part, comprising steps of:
providing a carbon steel part, a SiC ceramic part, and a Ni foil;
bringing surfaces of the carbon steel part, SiC ceramic part, and Ni foil into contact, with the Ni foil inserted between the carbon steel part and SiC ceramic part;
applying a pulsed electric current to the carbon steel part, SiC ceramic part, and Ni foil, heating the carbon steel part, SiC ceramic part, and Ni foil to a joining temperature of about 800-1100° C., and simultaneously applying a joining pressure of about 20-60 MPa to the carbon steel part, SiC ceramic part, and Ni foil while the current is applied, and maintaining the joining temperature and the joining pressure for about 10-30 minutes.

2. The process as claimed in claim 1, wherein the carbon steel part, SiC ceramic part, and Ni foil are heated at a rate of about 20° C./min before the temperature reaching about 300° C., then are heated at a rate of about 80-150° C. /min until the temperature reaches the joining temperature.

3. The process as claimed in claim 2, wherein when the temperature reaches about 300° C., the carbon steel part, SiC ceramic part, and the Ni foil begin to be pressed at a pressure of about 10 MPa, then the pressure steadily increases, until the temperature reaches the joining temperature, and the pressure reaches the joining pressure.

4. The process as claimed in claim 1, wherein the step of bringing surfaces into contact further comprises placing the carbon steel part, SiC ceramic part, and Ni foil in an electro-conductive clamping mold, wherein the clamping mold includes an upper pressing member and a lower pressing member, the upper pressing member and the lower pressing member from two opposite sides for compressing the carbon steel part, SiC ceramic part, and Ni foil therebetween.

5. The process as claimed in claim 4, wherein the joining pressure being applied to the carbon steel part, SiC ceramic part, and Ni foil through the upper pressing member and the lower pressing member.

6. The process as claimed in claim 4, wherein the step of applying the joining pressure further comprises placing the clamping mold in a sintering chamber of a spark plasma sintering device, and evacuating the sintering chamber to an internal pressure of about 6 Pa to about 10 Pa before applying the joining pressure.

7. The process as claimed in claim 6, wherein the spark plasma sintering device has a DC pulse power, the upper pressing member and the lower pressing member being respectively electrically connected with the positive electrode and the negative electrode of the DC pulse power.

8. The process as claimed in claim 1, wherein the Ni foil has a thickness of about 0.2-0.4 mm.

9. The process as claimed in claim 1, further comprising polishing and ultrasonically cleaning the carbon steel part, SiC ceramic part, and Ni foil, before the step of bringing into contact.

10. A composite article, comprising:
a carbon steel part;
a SiC ceramic part; and
a joining part connecting the carbon steel part to the SiC ceramic part, wherein the joining part is formed by placing a Ni foil between the carbon steel part and the SiC ceramic part, then heating by applying a pulsed electric current to the carbon steel part, SiC ceramic part, and the Ni foil, and simultaneously pressing the carbon steel part, SiC ceramic part, and the Ni foil.

11. The composite article as claimed in claim 10, wherein the joining part orderly includes a first transition layer adjacent to the carbon steel part, a Ni layer adjacent to the first transition layer, and a second transition layer located between the Ni layer and the SiC ceramic part.

12. The composite article as claimed in claim 11, wherein the first transition layer mainly comprises Ni-Fe solid solutions, and intermetallic compounds comprising Ni and Fe.

13. The composite article as claimed in claim 11, wherein the second transition layer mainly comprises compounds comprising Ni and C, and compounds comprising Ni and Si.

14. The composite article as claimed in claim 10, wherein the composite article has a shear strength of about 40-80 MPa.

15. A composite article, comprising:
a carbon steel part;
a SiC ceramic part; and
a joining part connecting the carbon steel part to the SiC ceramic part, wherein the joining part orderly includes a first transition layer adjacent to the carbon steel part, a Ni layer adjacent to the first transition layer, and a second transition layer located between the Ni layer and the SiC ceramic part.

16. The composite article as claimed in claim 15, wherein the first transition layer mainly comprises Ni-Fe solid solutions, and intermetallic compounds comprising Ni and Fe.

17. The composite article as claimed in claim 15, wherein the second transition layer mainly comprises compounds comprising Ni and C, and compounds comprising Ni and Si.
